(19) United States
(12) Patent Application Publication
(10) Pub. No.: US 2022/0213731 A1
(43) Pub. Date: Jul. 7, 2022

(54) EXTRUSION FOR MULTIPLE ELEMENTS

(71) Applicant: Rob J. Evans, Glendale, AZ (US)

(72) Inventor: Rob J. Evans, Glendale, AZ (US)

(21) Appl. No.: 17/112,859

(22) Filed: Dec. 4, 2020

Related U.S. Application Data
(60) Provisional application No. 62/943,422, filed on Dec. 4, 2019.

(51) Int. Cl. E06B 7/23

(52) U.S. Cl. CPC E06B 7/2309

(57) ABSTRACT

A safety edge bracket configured for fitment on a safety edge is provided. The safety edge bracket allows an elongated piece of weather strip to be attached over the safety edge to cushion the safety edge and to seal any gap between the edge and uneven flooring.

### CROSS-REFERENCE TO RELATED APPLICATIONS

This application claims the benefit of provisional application Ser. No. 62/943,422, filed on Dec. 4, 2019, the subject matter of which is incorporated herein by reference.

### TECHNICAL FIELD

The present disclosure relates generally to a motorized door system, and more particularly, to a safety edge bracket configured for fitment on a safety edge of the motorized door system.

### BACKGROUND

Motorized doors have many industrial and commercial uses. However, care must be taken when operating a motorized door. When a motorized door encounters a significant obstruction during closing, for instance, it may be necessary to immediately reverse the motor direction or halt the operation of the door in some other manner.

The prior art is replete with safety devices for motorized door systems, such as various types of safety edges. When a door is equipped with a safety edge, a signal is typically sent to halt or reverse the motor when the safety edge encounters an obstruction. In other cases, a signal given out by the safety edge may be interrupted, and the absence of the signal then triggers the control system to take appropriate action.

In the prior art motorized door 10 illustrated in FIG. 1, it is difficult to install doors equipped with safety edges at locations where the ground surface is not even. As can be seen in FIG. 1, when the door 10 is closed, a gap 12 i s formed between the door 10 and the ground 14. Over time, a safety edge 16 can become damaged due to excessive force being applied to the portion of the door 10 that touches the ground.

### BRIEF DESCRIPTION OF THE DRAWINGS

FIG. 1 shows a schematic front view of a conventional motorized door system.

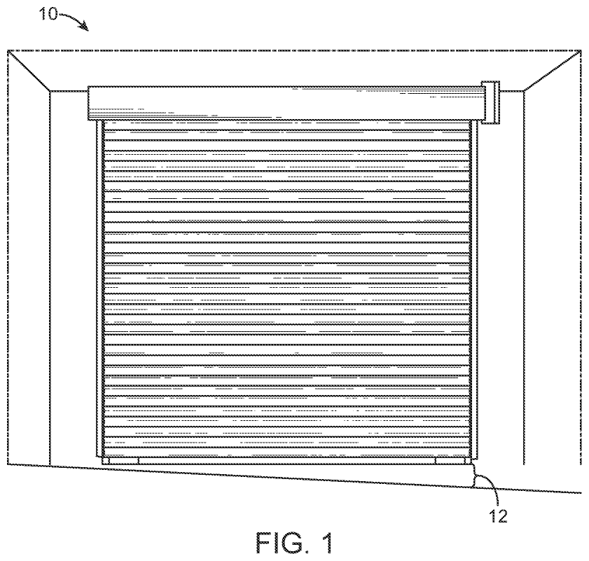

FIG. 2 shows a perspective view of a safety edge bracket for protecting a safety edge installed on a motorized door, according to the first embodiment of the disclosure.

FIG. 3 shows a front view of the safety edge bracket, according to the first embodiment of the disclosure.

FIG. 4 shows a perspective view of a safety edge bracket for protecting a safety edge installed on a motorized door, according to the second embodiment of the disclosure.

FIG. 5 shows a front view of the safety edge bracket, according to the second embodiment of the disclosure.

FIG. 6 shows a perspective view of a safety edge bracket for protecting a safety edge installed on a motorized door, according to the third embodiment of the disclosure.

FIG. 7 shows a front view of the safety edge bracket, according to the third embodiment of the disclosure.

### DETAILED DESCRIPTION OF EXAMPLE EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

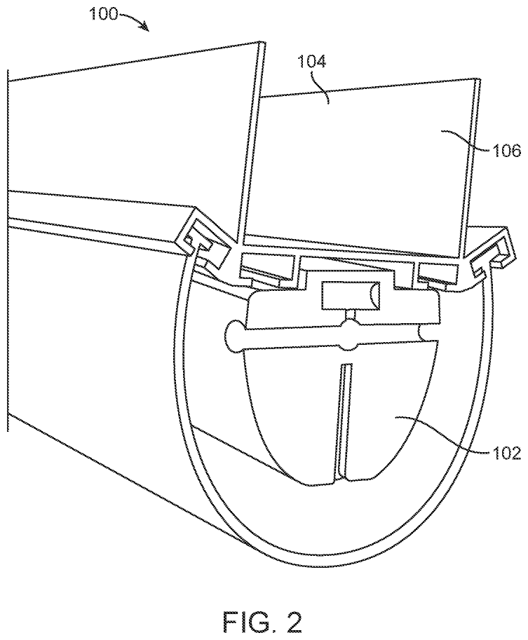

Referring to FIG. 2, a perspective view of a safety edge bracket 100 (hereinafter also referred to as bracket 100) for protecting a safety edge 102 installed on a motorized door, according to the first embodiment of the disclosure is illustrated. The bracket 100 comprises a first slot 104 defined by a first channel 106. In the first embodiment, the first channel 106 is a U-shaped channel that defines the first slot 104 for receiving the bottom edge of a motorized door therewithin. More specifically, the first slot 104 may be configured so as hold onto the motorized door in a tight fitment, in accordance with one embodiment. Additionally, an adhesive, nails, screws, etc. may be used.

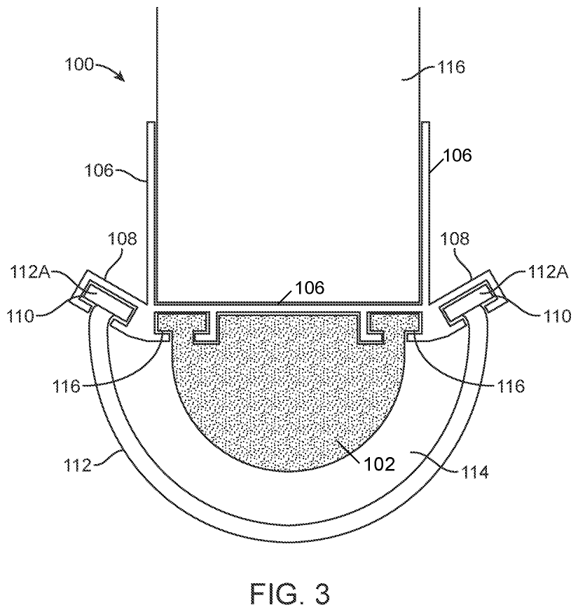

Referring to FIG. 3, a front view of the safety edge bracket 100, according to the first embodiment of the disclosure. The bracket 100 comprises a pair of extended channels 108 extending outwardly from both sides at a bottom end of first channel 106. Each of the pair of extended channels 108 define a slot 110. The slot 110 is configured to receive therein operative ends of a weather strip 112. In one embodiment, the weather strip 112 is a U-shaped strip having T-shaped ends attached to the bracket 100 by insertion of the T-shaped ends through the slots 110. As the weather strip 112 is attached to the bracket 100, a gap 114 is formed between the bottom surface of the bracket 100 and the inner surface of the weather strip 112. The weather strip 112 includes channels 112A which the operative ends of the weather strip 112, wherein the channels 112A have size and configuration complementary of that of the slots 110.

The bracket 100 further comprises first pair of slots 116 configured at an operative bottom surface of the first channel 106. The first pair of slots 116 facilitate the fitment of the safety edge 102 therein. More specifically, after assembly, the safety edge is accommodate within the gap 114 formed between the weather strip 112 and the bracket 100. In one embodiment, the gap 114 can be air gap. In another embodiment, the gap 114 may be filled with a cushioning material, e.g., Styrofoam.

As mentioned previously in the present specification, deployment of motorized doors at locations having an uneven ground surface causes application of excessive forces at some locations on the safety edge fitted on the motorized door. This compromises the operational life of the safety edge. An advantageous aspect of the using the bracket 100 on a motorized door 116 is that it facilitates the fitment of the weather strip 112 along with the safety edge 102. Therefore, any stresses or force acting on the motorized door 116 due to the unevenness of the ground surface are received by the weather strip 112 instead of the safety edge 102, as was the case with the conventional motorized door systems. The gap 114 prevents any undesired forces reaching the safety edge 102, thereby preserving the structural integrity of the safety edge 102. The weather strip 112, in accordance with one embodiment, may be made of a plastic material. Also, the modular fitment of the weather strip 112 to the bracket 100 facilitate an easy replacement thereof.

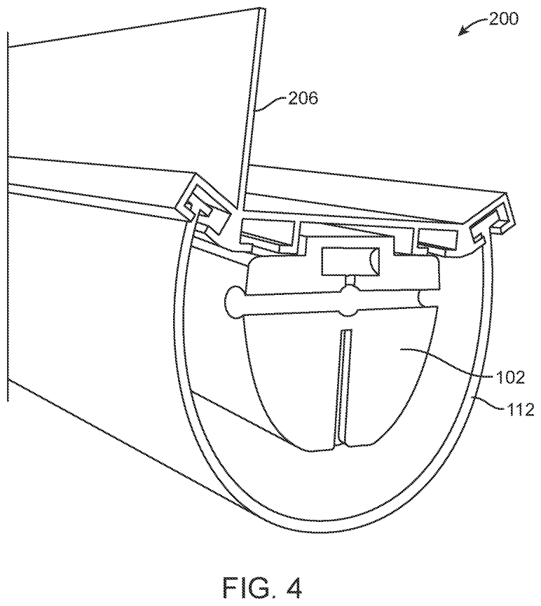

Referring to FIG. 4, a perspective view of a safety edge bracket 200 for protecting a safety edge 102 installed on a motorized door 116, according to the second embodiment of the disclosure is illustrated. The construction of the safety edge bracket 200 is similar to that of the safety edge bracket 100, with the exception of the configuration of the first channel 106. Therefore, the entire construction of the safety edge bracket 200 is not repeated herein for the sake of brevity of the present disclosure. Also, like elements of the safety edge brackets 100, 200 are denoted via like numerals for the sake of simplicity.

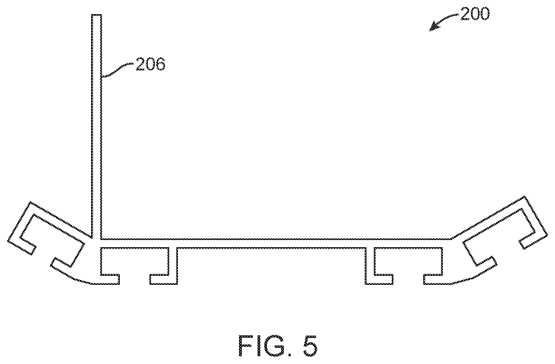

Referring to FIG. 5, As seen in FIG. 4 and FIG. 5, a first channel 206 of the safety edge bracket 200 has an L-shaped configuration. The first channel 206 includes a wall 206A, wherein the wall 206A of the bracket 200 may be configured to be received within a complementary slot on the motorized door, thereby securing the safety edge 102 as well as the weather strip 112 to the motorized door.

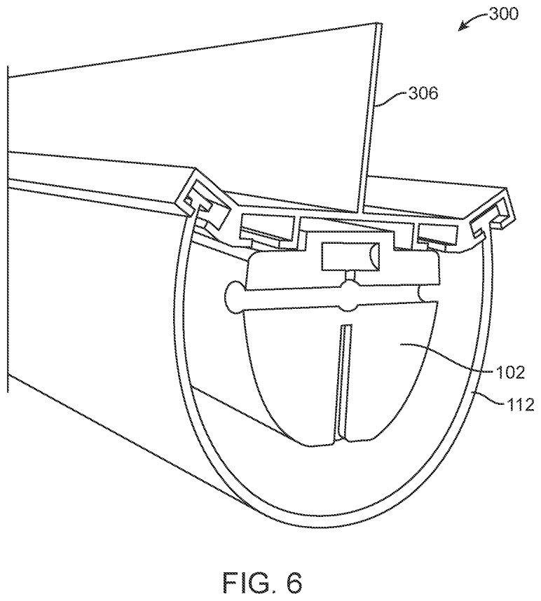

Referring to FIG. 6, a perspective view of a safety edge bracket 300 for protecting a safety edge 102 installed on a motorized door 116, according to the third embodiment of the disclosure is illustrated. The construction of the safety edge bracket 300 is similar to that of the safety edge bracket 100, with the exception of the configuration of the first channel 106. Therefore, the entire construction of the safety edge bracket 300 is not repeated herein for the sake of brevity of the present disclosure. Also, like elements of the safety edge brackets 100, 300 are denoted via like numerals for the sake of simplicity.

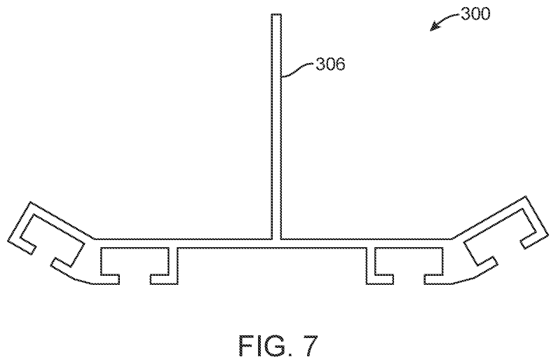

Referring to FIG. 7, a front view of the safety edge bracket 300, according to the third embodiment of the disclosure is illustrated. As seen in FIG.

6 and FIG. 7, a first channel 306 of the safety edge bracket 300 has a T-shaped configuration. The first channel 306 includes a wall, wherein the wall of the bracket 300 may be configured to be received within a complementary slot on the motorized door, thereby securing the safety edge 102 as well as the weather strip 112 to the motorized door.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A safety edge bracket configured for fitment on a bottom edge, comprising:
an elongated strip attachable to the bottom edge above it and including a s safety edge holder adapted to secure a safety edge below it;
dual weather strip slots on opposite sides of the elongated strip, the dual slots each adapted to secure a weather strip below the safety edge.

2. The safety edge bracket of claim 1, wherein elongated strip is adapted to leave a gap between the weather strip and the safety edge.

3. The safety edge bracket of claim 1, wherein the weather strip forms a U-shaped arrangement below the safety edge.

4. The safety edge bracket of claim 1, wherein the weather strip encapsulates the safety edge.

5. The safety edge bracket of claim 1, wherein the dual weather strip slots are adapted to accommodate T-shaped ends of the weather strip.

6. The safety edge bracket of claim 5, wherein the dual weather strip slots are adapted to allow the T-shaped ends of the weather strip to inserted into the respective slots.

7. The safety edge bracket of claim 1, where in the bottom edge is a bottom edge of a motorized door.

8. The safety edge bracket of claim 7, wherein the elongated strip is attached to the bottom edge of the motorized door using a U-shaped door securing device.

9. The safety edge bracket of claim 7, wherein the elongated strip is attached to the bottom edge of the motorized door using a L-shaped door securing device.

10. The safety edge bracket of claim 7, wherein the elongated strip is attached to the bottom edge of the motorized door using a U-shaped door securing device.

11. The safety edge bracket of claim 2, wherein the gap is an air gap.

12. The safety edge bracket of claim 2, wherein the gap is filled with a cushioning material.

13. A safety edge bracket configured for fitment on a bottom edge of a motorized door, comprising:
an elongated strip attachable to the bottom edge above it and including a safety edge holder adapted to secure a safety edge below it;
dual weather strip slots on opposite sides of the elongated strip, the dual slots each adapted to secure T-shaped ends of a weather strip below the safety edge.

14. The safety edge bracket of claim 1, wherein elongated strip is adapted to leave a gap between the weather strip and the safety edge.
